(19) United States
(12) Patent Application Publication
(10) Pub. No.: US 2004/0015861 A1
(43) Pub. Date: Jan. 22, 2004

(54) Managing content with multi-site and single point of control

(76) Inventor: Dhananjay A. Nagalkar, Randolph, NJ (US)

Correspondence Address: PILLSBURY WINTHROP LLP, 725 S. FIGUEROA STREET, SUITE 2800, LOS ANGELES, CA, 90017, US

(21) Appl. No.: 09/836,331

(22) Filed: Apr. 18, 2001

(51) Int. Cl. G06F 19/00

(52) U.S. Cl. 717/124; 700/95; 700/97; 714/38

(57) ABSTRACT

An arrangement is provided for centralized content management. A central site supports a generic product with a plurality of features. At least one development site connects to the central site. Each development site can generate and test a customized product of the generic product based on the features of the generic product via tools provided by the central site.

### RESERVATION OF COPYRIGHT

This patent document contains information subject to copyright protection. The copyright owner has no objection to the facsimile reproduction by anyone of the patent document or the patent, as it appears in the U.S. Patent and Trademark Office files or records but otherwise reserves all copyright rights whatsoever.

### BACKGROUND

Aspects of the present invention relate to content management. Other aspects of the present invention relate to centralized digital content management.

In our computer age, content is often in digital form. Content is provided in numerous formats and file types. For example, content may be a software product, implementation of a protocol standard, a web site, etc. Content may evolve both substantively and in format. For instance, a software product may be revised over time by a development team, generating version after version as the product becomes more feature rich. A web site may need to be updated from time to time to include new content or as to form. Content may also evolve through variants. For example, a computer application may have plural language specific versions that are essentially equivalent in operation except for the language interface with the user. A company's web site may be implemented with identical content, but in different languages for audiences in different countries. The language variants of the web site may all have the same look and feel (same construct). A standard protocol may have custom protocol modules for different countries.

With the ever increasing evolution of content, the management of content is becoming increasingly difficult. Content must be managed. The management of evolving content poses particular challenges. Conventionally, variants of content, including the ones introduced by updating with time and the ones introduced by customizations have been managed separately. For example, a software product may first be developed by a development team and then distributed to deployment centers that each customize the software product and generate its own variant to fit local needs. Different variants are developed and maintained at different sites even though the variants have many common attributes.

This approach to content management is costly because development and maintenance teams at different sites duplicate work. Common properties of the product are maintained individually. Whenever changes to such common properties occur, the changes in the variants (although they are actually the same changes) are made separately at different sites. This approach also runs the risk of inconsistency in product because any miscommunication or lack of coordination among different sites may result in one or more variants not being updated timely and correctly.

### BRIEF DESCRIPTION OF THE DRAWINGS

The inventions presented herein are described in terms of specific exemplary embodiments which will be described in detail with reference to the drawings. These embodiments are non-limiting exemplary embodiments, in which like reference numerals represent similar parts throughout the several views of the drawings, and wherein:

FIG. 1 depicts high level architecture of embodiments of the inventions;

FIG. 2 depicts in more detail the internal structure of a central site and its relationship with a plurality of development sites;

FIG. 3 presents an exemplary construct of a customized product;

FIG. 4 illustrates how a development site interacts with a visual customization tool;

FIG. 5 illustrates a process, in which a customized product is constructed based on the features of a generic product;

FIG. 6 shows the block diagram of a central site, in relation to a development site; and

FIG. 7 is an exemplary flowchart of a process, in which a development site builds a customized product based on a generic product controlled by a central site.

### DETAILED DESCRIPTION

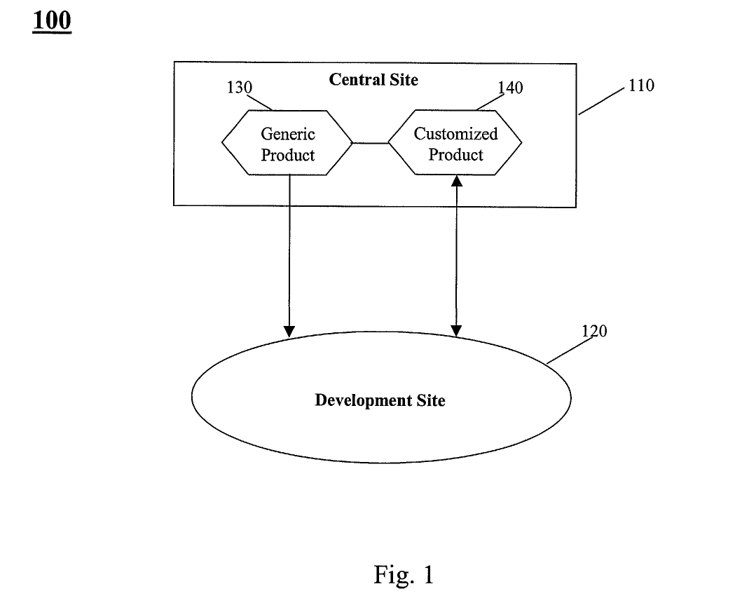

FIG. 1 depicts the high level architecture of embodiments of the inventions. System 100 comprises a central site 110 that manages a generic product 130 and a development site 120 that interacts with the central site 110 to produce a customized product 140 based on the generic product 130. The development site 120 may correspond to a deployment or distribution center (not shown in FIG. 1). The customized product 140 may be stored either at the central site 110 or at the development site 120 (not shown in FIG. 1).

The generic product 130 may represent any of a variety of products. For example, the generic product 130 may represent web site content, including a plurality of html files, image files, sound files, etc. The generic product 130 may also be a computer files that defines a protocol. The generic product 130 may define a set of features. For instance, a web site may comprise a plurality of buttons (features) with certain text displayed on each button (feature values) indicating the function of the button (e.g., a button with text “Save” on it). A protocol may specify different features such as “collecting digits” and “call progress”.

A generic product is supported through its features. The central site 110 supports the generic product 130 by executing some or all the features of the generic product using specific characteristics or by instantiating the feature values. For example, the buttons on a web site are supported if the buttons can be rendered on a display screen with proper text in certain language (e.g., in English) rendered on the button. As another example, the feature “call progress” of a protocol may be associated with certain characteristics such as tone frequency (feature value). Without instantiated feature values, a feature may not be supported or supported with the default values provided by the generic product.

The generic product 130 managed by the central site 110 carries features desired by most of its customers and these features are supported by the central site 110. The central site 110 may be connected to one or more development sites (only one such site is shown in FIG. 1 for convenience). Both the generic product 130 and the customized product 140 may be shipped to a development site for use. For example, a non web-based products may be shipped to a deployment center. The development site 120 may utilize the generic product 130 to generate a customized product 140. Customization may be performed with respect to the features of the generic product and may involve several aspects. For example, the development site 120 may choose to use a partial set of the features supported by the generic product 130. The development site 120 may also choose to instantiate selected features using customized feature values. Furthermore, the development site 120 may also reconfigure the relationship among selected features.

Once a customized product is generated, it may be tested, maintained, and upgraded at the central site 110 at a single point of control. A customized product may also be used as a new feature of the generic product 130 so that the new feature can be made available to other development sites which generate further customized products based on the previously customized product.

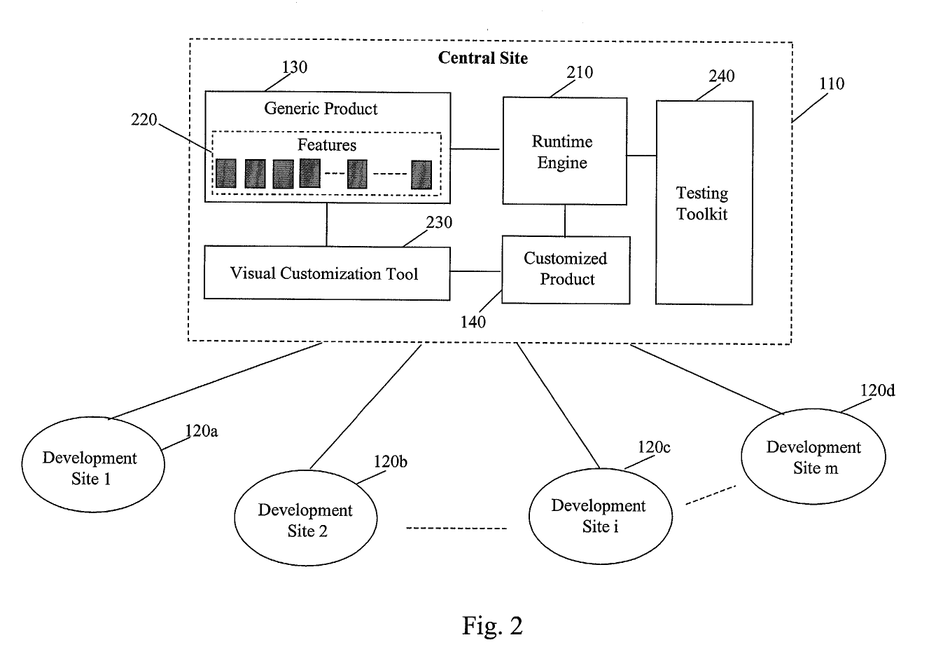

FIG. 2 depicts, in more detail, the internal structure of the central site 110 and how different parts of the central site 110 interact with a plurality of development sites. The central site 110 is connected to a plurality of development sites (development site 1, 120a, development site 2, 120b, . . . , development site i, 120c, . . . , development site m, 120d). The central site 110 develops a generic product 130 with a plurality of features 220, a visual customization tool 230, customized product 140, a runtime engine 210, and a testing toolkit 240.

The visual customized tool 230 may comprise a collection of tools with a graphical user interface, providing visual means for a user to manipulate features 220. Examples of such manipulation include activating or deactivating features, rearranging the sequence of the features and setting customized values on different features. The testing toolkit 240 may comprise a collection of tools through which a user who interacts with the central site 110 to generate customized products can test the customized product at the central site 110. Examples of testing tools include a trigger that is activated by a user and invokes the runtime engine 210 to execute a specified customized product. The testing toolkit 240 may also provide a debugger that allows a user to set up traces in a customized product and generates useful information for debugging purposes.

A development site, such as development site 1 (120a) communicates with the central site 110 via both the visual customization tool 230 and the testing toolkit 240. To develop a customized product (e.g., 140), the development site 120a interacts with the visual customization tool 230, which has access to all the features of the generic product 130. The development site 120a builds the customized product 140 by making customizations to the features 220 via the visual customization tool 230.

Once the customized product 140 is generated, it can be tested by the runtime engine 210. The testing may be activated or triggered by the development site 120a via the testing toolkit. During the testing, the runtime engine 210 may access the configuration of the customized product 140 and execute the customized features. The runtime engine 210 may also generate debug information during the testing. Such debug information may be communicated back to the development site 120a via the testing toolkit 240.

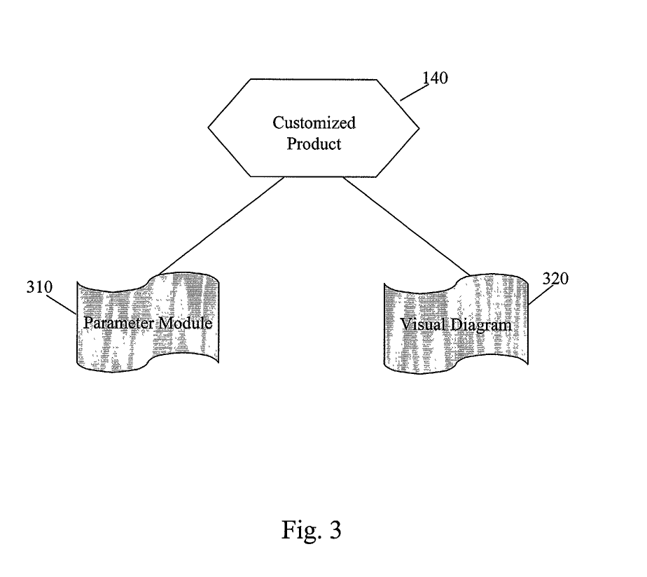

FIG. 3 presents an exemplary construct of a customized product. In FIG. 3, a customized product 140 may include two parts: a parameter module 310 and a visual diagram 320. Both the parameter module 310 and the visual diagram 320 describe the configuration information that is specific to a particular customized product. The former is to select, from all the available features (220) at the central site 110, a set of features with certain customized values to be used in the customized product. The latter is to specify how the selected features are tied together.

The parameter module 310 may contain site dependent parameters that specify what features from the generic product 130 to be used with what customized characteristics. For example, a partial set of buttons and associated functions (features) may be selected to customize a web site for a company's web site in Japan and Japanese is specified as the language used to display the text on the buttons.

The visual diagram 320 represents a configuration in which selected features (specified in the parameter module) are tied together. For example, a button (a feature) selected representing “check out” at an e-commerce web site may be linked to a program (a different feature) that performs the function of billing.

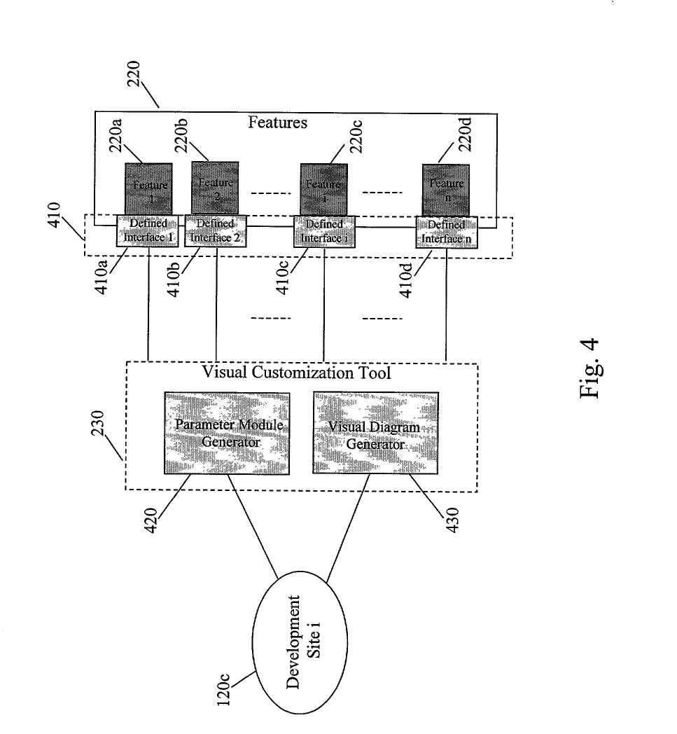

FIG. 4 shows how the parameter module 310 and the visual diagram 320 may be constructed from the features 220 via the visual customization tool 230. The visual customization tool 230 comprises a parameter module generator 420 and a visual diagram generator 430. To allow a development site (e.g., 120c) to customize the generic product 130, each of the features (220a220b, . . . ,220c, . . . ,220d) is associated with a defined interface (410a, 410b, . . . ,410c, . . . ,410d) which is accessible or can be invoked by the visual customization tool 230. Through defined interfaces 410, various aspects of corresponding features may be customized.

To generate a parameter module, a development site (e.g., 120c) may interact with the parameter module generator 420. During the interaction, the parameter module generator 420 may present the development site 120c all the available features and provide the (visual) means for the development site 120c to select desired features. For the selected features, the parameter module generator 420 may access their corresponding defined interfaces through which the development site 120a can specify customized values. Based on the selected features, the visual diagram generator 430 may provide the means for the development site 120c to visually construct a diagram in which the selected features are connected according to the needs of the customized product.

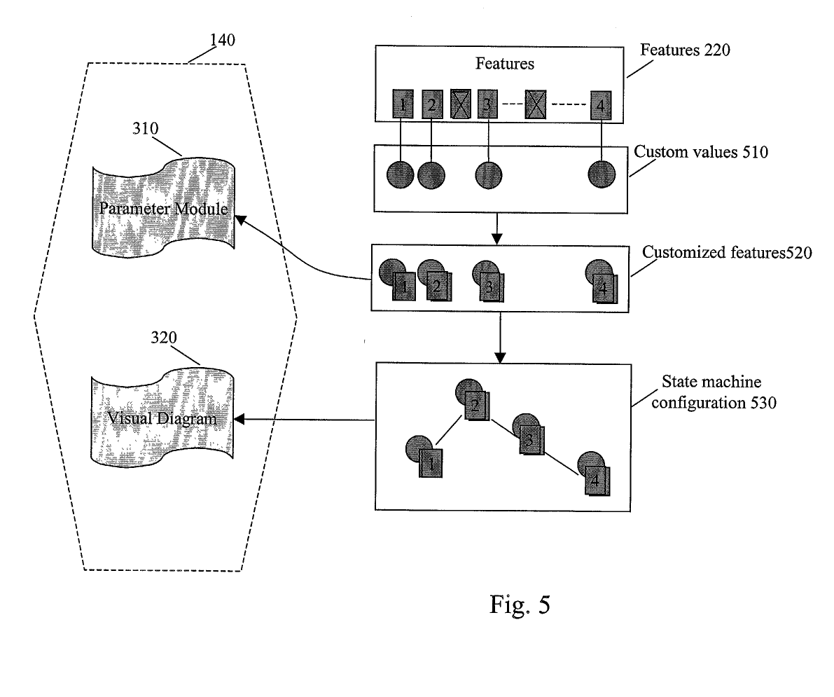

The process of building a customized product based on the features of a generic product is illustrated in FIG. 5. In FIG. 5, the flow of different acts in constructing a customized product is shown on the right. The results (the parameter module and the visual diagram) of such construction are shown on the left. The features 220 of the generic product 130 is first presented to the development site. Through visual means (provided by the parameter module generator 420), the development site may select some features. For example, in FIG. 5, four features are selected or activated (1,2,3,4). The ones that are marked with Xs are deactivated.

Each of the selected features may be customized using some custom values. This is illustrated by custom values 510. Each shaded circle in FIG. 5 represents a set of custom values for a particular feature and is linked to its underlying feature. The association between custom values with selected features forms customized features 520, which corresponds to a parameter module 310.

In FIG. 5, four customized features are specified based on the four (1,2,3,4) selected features. The customized features 520 are then used to build a diagram, in which the four selected features form a tree with feature 1 being a child of feature 2, feature 3 being a child of feature 2, and feature 4 being a child of feature 3. The tree corresponds to a visual diagram 320, that specifies a state machine configuration (530).

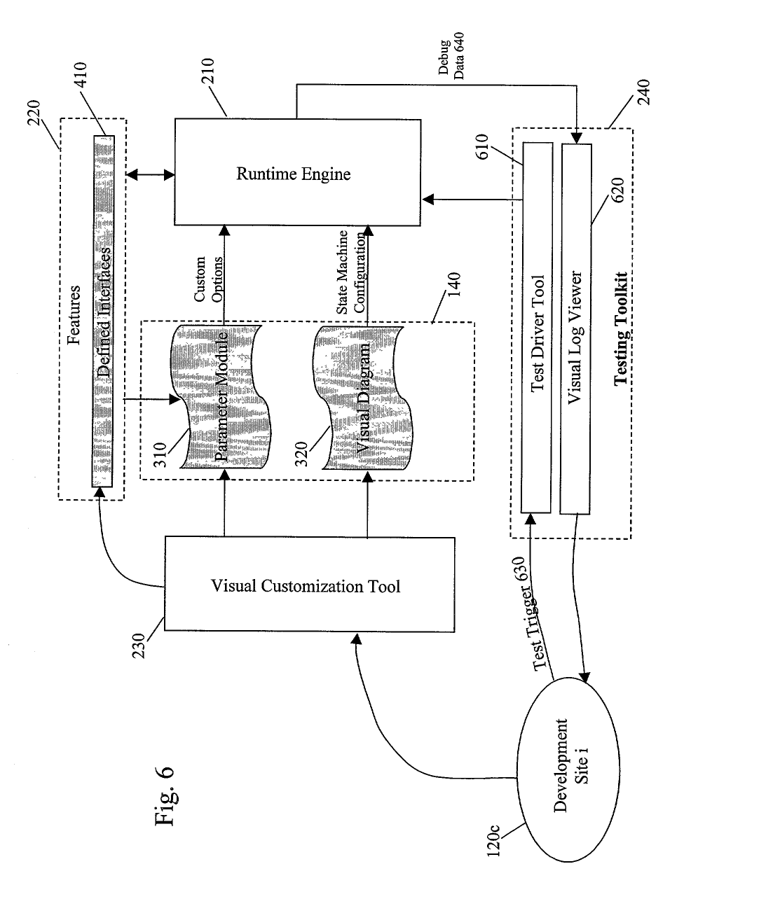

The parameter module 310 specifies the custom options relevant to a customized product. The visual diagram 320 provides the state machine configuration of the customized product. Together, they define a customized product, which is built based on the generic product 130 with necessary customizations. The runtime engine 210 may support a customized product in a similar fashion as it supports the generic product 110 but execute the selected features according to the custom specifications provided in both the parameter module and the visual diagram of the customized product. This is shown in FIG. 6.

In FIG. 6, a development site 120c builds a customized product 140 based on features 220. The customized product is constructed via the visual customization tool 230 through the defined interfaces 410 of the features. The construction generates a parameter module 310 and a visual diagram 320. The former specifies the custom options with respect to the customized product 140 and the latter specifies the state machine configuration of the customized product.

The runtime engine 210 may be used to test the customized product 140. The testing may be triggered or activated by the development site 120c via the testing toolkit 240. In FIG. 6, the testing toolkit comprises a test driver tool 610 and a visual log viewer 620. Through the test driver tool 610, the development site 120c requests, via a test trigger 630, the runtime engine 210 to test (or run) the customized product 140. To test the customized product 140, the runtime engine 210 accesses both parameter module 310 and the visual diagram 320 and executes the customized features (specified by the parameter module 310) according to the state machine configuration (specified by the visual diagram 320).

During the testing, the runtime engine 210 may generate debug data 640. Such debug data may be fed to the visual log viewer 620 so that the development site 120a can visually observe the testing status. Based on the debug data 640, the development site 120c may revise the customized product 140 by repeating the construction acts (as described above).

The customized product 140, once tested, may remain at the central site 110. In this case, the customized product may be used as a new feature (or a new composite feature constructed based on existing features) of the generic product 130 and its future maintenance and upgrades may be performed at the central site 110. This new feature may be made accessible to the development sites connecting to the central site 110 so that other customized products may be built based on it.

The customized product 140 may also be sent to a development site, which may be the development site that builds the product or a different development site. In this case, the customized product 140 is solely hosted by the development site. That is, the customized product 140 may be accessible only by the development site that hosts it. Subsequently, the hosting development site may perform future maintenance and upgrades of the customized product.

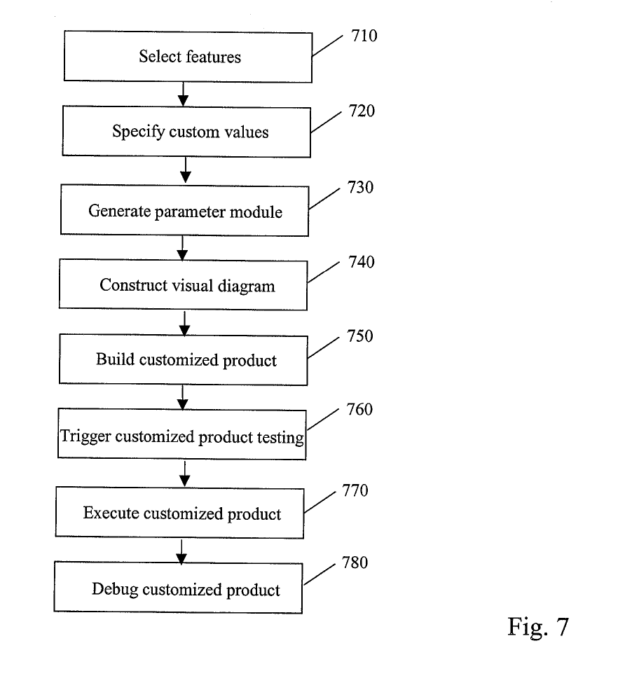

An exemplary flowchart of the process of generating, by a development site, a customized product based on a generic product, that is controlled at a single point of control at a central site, is shown in FIG. 7. A development site first selects, at 710, various features of a generic product. For selected features, their customized values are specified at 720. Based on selected features and their custom values, a parameter module is generated at 730. A visual diagram is constructed at 740. The construction ties the selected features together to form a state machine with the configuration specified by the diagram. Using both the parameter module, generated at 730, and the visual diagram, constructed at 740, a customized product is built at 750.

It may not be nessary to construct the visual diagram during the customization. In certain situations, it may suffice to customize only the paramter module. When the configuration of the generic product does not fit the requirement of a cumstomized product, a visual diagram may need to be constructed according to the requirements of the customized product.

The development site may further trigger, at 760, the runtime engine at the central site to test the customized product. The runtime engine accesses the parameter module and the visual diagram and executes the customized product at 770. Debug data may be generated by the runtime engine during the execution and visually displayed to the development site. Based on the debug data, the customized product is debugged at 780, which may involve repeated product construction (to revise the customized product) and testing (to debug the revised customized product) between 710 and 770.

The processing described above may be performed by a general-purpose computer alone or in connection with a special purpose computer. Such processing may be performed by a single platform or by a distributed processing platform. In addition, such processing and functionality can be implemented in the form of special purpose hardware or in the form of software being run by a general-purpose computer. Any data handled in such processing or created as a result of such processing can be stored in any memory as is conventional in the art. By way of example, such data may be stored in a temporary memory, such as in the RAM of a given computer system or subsystem. In addition, or in the alternative, such data may be stored in longer-term storage devices, for example, magnetic disks, rewritable optical disks, and so on. For purposes of the disclosure herein, a computer-readable media may comprise any form of data storage mechanism, including such existing memory technologies as well as hardware or circuit representations of such structures and of such data.

While the invention has been described with reference to the certain illustrated embodiments, the words that have been used herein are words of description, rather than words of limitation. Changes may be made, within the purview of the appended claims, without departing from the scope and spirit of the invention in its aspects. Although the invention has been described herein with reference to particular structures, acts, and materials, the invention is not to be limited to the particulars disclosed, but rather extends to all equivalent structures, acts, and, materials, such as are within the scope of the appended claims.

What is claimed is:

1. A system for managing content, comprising:
a central site for supporting a generic product with a plurality of features; and
at least one development site connecting to the central site, each of the at least one development site generating a customized product of the generic product based on the plurality of features, testing said customized product, and maintaining said customized product at said central site.

2. The system according to claim 1, wherein the central site comprises:
a runtime engine for performing the plurality of features of the generic product; and
a visual customization tool for interfacing with the at least one development site to create the customized product of the generic product based on the plurality of features, the customized product created using the visual customization tool interacting with the runtim engine.

3. The system according to claim 2, wherein each of the plurality of features corresponds to a defined interface which can be invoked from the visual customization tool.

4. The system according to claim 2, wherein the custom product comprises:
a parameter module generator for activating a portion of the plurality of features with custom values via the defined interface of each feature in the portion; and
a visual diagram generator for configuring the portion of features that are activated through the activating by the parameter module generator to generate a state machine configuration.

5. The system according to claim 2, further comprising a testing toolkit which includes:
a test driver tool for triggering the runtime engine to perform a test on the customized product; and
a visual log viewer for visually viewing debug data generated by the runtime engine during the test on the customized product.

6. A method for managing content, comprising:
building, by a development site connecting to a central site via a visual tool provided by said central site, a customized product of a generic product, maintained at said central site, based on a plurality of features associated with the generic product; and
testing the customized product at the central site.

7. The method according to claim 6, wherein the generic product includes a web site.

8. The method according to claim 6, wherein the generic product includes a protocol.

9. The method according to claim 6, wherein the customized product includes a customized web site.

10. The method according to claim 6, wherein the customized product includes a variant of a protocol.

11. The method according to claim 6, wherein the building comprises:
selecting a portion of the plurality of features of the generic product;
specifying custom values for the portion of the plurality of features;
generating a parameter module based on the portion of the plurality of features and the custom values for the portion of the plurality of features, the parameter module activating the portion of the plurality of features with the custom values; and
constructing a visual diagram using the portion of features, the visual diagram configuring the portion of the plurality of features to form a state machine.

12. The method according to claim 11, wherein
the selecting is performed via a parameter module generator in a visual customization tool; and
the specifying is performed through defined interfaces of the portion of the plurality of features via the parameter module generator; and
the constructing is performed via a visual diagram generator in the visual customization tool.

13. The method according to claim 1 1, wherein the testing comprises:
triggering, by the development site through a test driver tool, a runtime engine at the central site to test the customized product; and
executing, by the runtime engine, the customized product based on the parameter module and the visual diagram.

14. The method according to claim 13, further comprising:
generating, by the runtime engine, debug data based on the executing the customized product;
displaying the debug data on a visual log viewer; and
debugging, by the development site, the customized product based on the debug data displayed on the visual log viewer.

15. A computer-readable medium encoded with a program for managing content, the program comprising:
building, by a development site connecting to a central site via a visual tool provided by said central site, a customized product of a generic product, maintained at said central site, based on a plurality of features associated with the generic product; and
testing the customized product at the central site.

16. The medium according to claim 15, wherein said building via a visual tool comprises:
selecting a portion of the plurality of features of the generic product;
specifying custom values for the portion of the plurality of features;
generating a parameter module based on the portion of the plurality of features and the custom values for the portion of the plurality of features, the parameter module activating the portion of the plurality of features with the custom values; and
constructing a visual diagram using the portion of features, the visual diagram configuring the portion of the plurality of features to form a state machine.

17. The medium according to claim 16, wherein the testing comprises:
triggering, by the development site through a test driver tool, a runtime engine at the central site to test the customized product; and
executing, by the runtime engine, the customized product based on the parameter module and the visual diagram.

18. The medium according to claim 17, further comprising:
generating, by the runtime engine, debug data based on the executing the customized product;
displaying the debug data on a visual log viewer; and
debugging, by the development site, the customized product based on the debug data displayed on the visual log viewer.
